(19) United States
(12) Patent Application Publication
(10) Pub. No.: US 2003/0149600 A1
(43) Pub. Date: Aug. 7, 2003

(54) Reservation entry method and system

(75) Inventor: Paula S. Williams, Bal Harbour, FL (US)

Correspondence Address: Kirk D Houser, Eckert Seamans Cherin and Mellott LLC, 600 Grant Street 44th Floor, Pittsburgh, PA, 15219, US

(73) Assignee: ECKERT SEAMANS CHERIN AND MELLOTT LLC

(21) Appl. No.: 09/556,153

(22) Filed: Apr. 21, 2000

(51) Int. Cl. G06F 17/60; G06F 15/16

(52) U.S. Cl. 705/5; 709/203; 715/513

(57) ABSTRACT

A computer system for entering a reservation includes a client system, such as a personal computer (PC) client; a server system including a web server, an application server and a host reservation and database system; and a global communication system, such as the Internet, between the PC client and the server system. The PC client includes a display sub-system, such as a browser, for displaying information identifying a vehicle rental to be reserved, such as a car rental; a data entry sub-system cooperating with the display sub-system and generating a single action; and a communication sub-system cooperating with the data entry sub-system. The host reservation and database system includes a car club's car rental database which stores profile information for a plurality of car rental club members. The server system also includes a receiving component which receives a car rental club number that identifies a car rental club member, and receives a request to reserve the car rental for the member, with the request being sent in response to only the single action. A retrieval component retrieves the stored profile information from the car rental database for the member identified by the identifier, and a reservation entry component generates a reservation to reserve the car rental for the member by using the retrieved stored profile information. The Internet sends the car rental club number to the server system, and in response to only the single action being performed, sends the request to the server system.

### BACKGROUND OF THE INVENTION

1. Field of the Invention

The present invention relates to a method and system for entering a reservation and, more particularly, to a computer method and system for reserving an item or service, such as a vehicle rental, over a communication network, such as the Internet.

2. Background Information

The Internet comprises a vast number of computers and computer networks that are interconnected through communication links. The interconnected computers exchange information using various services, such as electronic mail (i.e., email), and the World Wide Web (“WWW”). The WWW service allows a server computer system (e.g., a web server, a web site) to send graphical web pages of information to a remote client computer system. The remote client computer system can then display the web pages. Each resource (e.g., computer, web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

The World Wide Web is especially conducive to conducting electronic commerce (i.e., e-commerce). Many web servers have been developed through which vendors can advertise and sell products or enter reservations for items or services, such a vehicle rentals.

The current processes for obtaining car rental reservations on the Internet are lengthy and time consuming. For example, one web site requires that the user enter data in about thirty data fields and perform about seven mouse clicks to process that data. Then, only after the seventh click, has the user reserved the desired car.

For example, one reservations process begins when the user enters his/her last name and car rental club number, and then clicks to continue. On the subsequent rental information page, the user enters or selects: Country of Residence, Pick-up (or Rental) Location (alternatively, the user may search for the Rental Location, which involves an additional three-step process), Pick-up Date (day, month, year), Pickup Time (hour, minute, a.m. or p.m.), Return Location (if different from Pick-up Location), Return Date (day, month, year), and Return Time (hour, minute, a.m. or p.m.). Optionally, the user may also enter or select flight information, such as Flight Number, additional equipment, promotional codes or coupon ID numbers.

Next, the user clicks “Continue” to access a rental club location confirmation page. On this second page, the user may click on a link for “Change Rental/Return Information” or select a “Car Class” and click “Continue”.

When the user clicks to select a Car Class, a third page for “Optional Information” is displayed. On this page, the user may select: a Booster Seat, a Child Seat, or a Ski Rack; enter a Coupon ID; enter a Product or Rate Code; or select the service level for the rental (e.g., one or more different types of car club reservation services, or counter service).

Next, the user clicks “Continue” to access a fourth page for “Estimated Billing”. This page provides a visual confirmation of: Pick-up Location, Pick-up Date, Pick-up Time, Drop-off Location, Drop-off Date, Drop-off Time, rental Contract ID Number (if any), user Company Association, user Company Name, Length of Rental, and Rental/Rate Information (e.g., Car Class, “Time and Distance” Rate Breakdown, Prices, and a break out of estimated charges, such as Subtotal, Insurance Calculation, Coverage Description, Surcharges, Taxes, Total Estimate, and Rules and Conditions).

Finally, the user may enter his/her “E-mail Address” and clicks a “Complete” link to complete the reservation. This displays a fifth page for “Confirmation” of the reservation, which provides the same type of information as the “Estimated Billing” page, with the addition of the type of car rental club service that the user will receive at the particular pick-up location.

Accordingly, there is room for improvement in systems and methods for entering reservations.

### SUMMARY OF THE INVENTION

This need and others are met by the present invention, which, in response to only a single action being performed, sends a request to reserve an item or service, such as a vehicle rental.

In accordance with the invention, a method of entering a reservation includes, under control of a client system, sending an identifier of a person to a server system, displaying information identifying an item or service to be reserved, and in response to only a single action being performed, sending a request to reserve the item or service for the person identified by the identifier to the server system; and, under control of the server system, receiving the identifier, retrieving additional information previously stored for the person identified by the identifier, receiving the request, and generating a reservation to reserve the item or service for the person identified by the identifier using the retrieved additional information.

As another aspect of the invention, a client system for entering a reservation includes a display component displaying information identifying an item or service to be reserved; a data entry component cooperating with the display component; and a communication component cooperating with the data entry component. The communication component sends an identifier, which identifies a person, to a server system, in order that the server system can retrieve additional information based upon the identifier needed to complete the reservation, and in response to only a single action being performed, sends a request to the server system to reserve the item or service for the person.

As a further aspect of the invention, a server system for entering a reservation includes a data storage component storing information for a plurality of persons; a receiving component receiving an identifier, which identifies a person, and receiving a request to reserve an item or service for the person, with the request being sent in response to only a single action being performed; a retrieval component retrieving the stored information from the data storage component for the person identified by the identifier; and a reservation entry component generating a reservation to reserve the item or service for the person identified by the identifier using the retrieved stored information.

As another aspect of the invention, a method for reserving an item or service using a client system includes employing an identifier which identifies a person; sending the identifier to a server system, the server system for retrieving additional information based upon the identifier and needed to complete a reservation; displaying information which identifies the item or service to be reserved; and sending, in response to only a single action being performed, a request to the server system to reserve the item or service for the person.

As a further aspect of the invention, a method for reserving an item or service using a server system includes storing information for a plurality of persons; receiving an identifier of a person; retrieving the stored information for the person identified by the identifier; receiving a request to reserve the item or service for the person, with the request being sent in response to only a single action being performed; and generating the reservation to reserve the item or service for the person identified by the identifier using the retrieved stored information.

As another aspect of the invention, a computer system for entering a reservation includes a client system, a server system, and a communication system between the client system and the server system. The client system includes a display component displaying information identifying an item or service to be reserved, a data entry component cooperating with the display component, and a communication component cooperating with the data entry component. The server system includes a data storage medium storing information for a plurality of persons; a receiving component receiving an identifier, which identifies a person, and receiving a request to reserve an item or service for the person, with the request being sent in response to only a single action being performed; a retrieval component retrieving the stored information from the data storage component for the person identified by the identifier; and a reservation entry component generating a reservation to reserve the item or service for the person identified by the identifier using the retrieved stored information. The communication system sends the identifier to the server system, and in response to only the single action being performed, sends the request to the server system.

### BRIEF DESCRIPTION OF THE DRAWINGS

A full understanding of the invention can be gained from the following description of the preferred embodiments when read in conjunction with the accompanying drawings in which:

FIG. 1 is a block diagram of a reservation system in accordance with an embodiment of the present invention.

FIG. 2 is a block diagram of a client/server reservation system in accordance with another embodiment of the present invention.

FIG. 3A is a home web page display for the reservation system of FIG. 2.

FIG. 3B is a Rental Information web page display for the reservation system of FIG. 2.

FIG. 3C is a Confirmation web page display for the reservation system of FIG. 2.

FIGS. 4A-4B are flow diagrams of a server system routine for the reservation system of FIG. 2.

FIG. 5 is a flow diagram of a client system routine for the reservation system of FIG. 2.

FIG. 6A is a block diagram of a client system employing voice-activated single action reservations.

FIG. 6B is a block diagram of a client system employing TV remote control-activated single action reservations.

FIG. 6C is a block diagram of a client system employing key-pad-activated single action reservations.

FIG. 6D is a block diagram of a client system employing touchscreen-activated single action reservations.

FIG. 7 is a block diagram of a client/server system which employs an email confirmation message.

### DESCRIPTION OF THE PREFERRED EMBODIMENTS

As employed herein, the term “vehicle” shall expressly include, but not be limited to, any new or used vehicle having pneumatic tires, such as, for example, land-based vehicles, automobiles, cars, trucks, sport utility vehicles (SUVs), vans, motorcycles, mopeds, campers, trailers, and bicycles.

As employed herein, the term “item” shall expressly include, but not be limited, to any product or good which is available for reservation, such as, for example, a vehicle.

As employed herein, the term “service” shall expressly include, but not be limited, to any service which is available for reservation, such as, for example, a vehicle rental service.

As employed herein, the term “communication network” shall expressly include, but not be limited to, any local area network (LAN), wide area network (WAN), intranet, extranet, global communication network, and the Internet.

As employed herein, the term “person” shall expressly include, but not be limited to, a natural person, firm, corporation, association, group or organization.

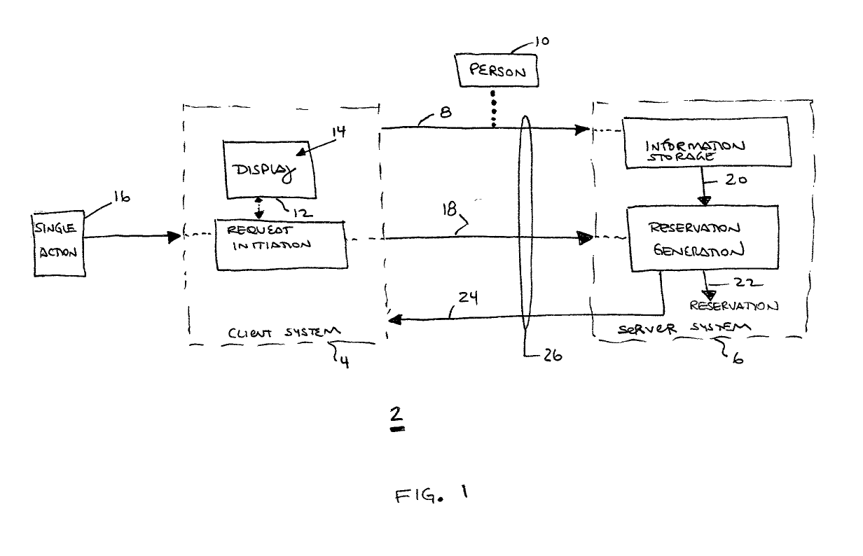

FIG. 1 shows an exemplary reservation system 2 including a client system 4 and a server system 6. The client system 4 sends an identifier 8 of a person 10 to the server system 6. As a non-limiting example, the identifier 8 may be a log-in name. Preferably, a password is also employed. The client system 4 includes a display 12 which displays information 14 which identifies an item or service to be reserved. Preferably, the information 14 is displayed on a single screen. In response to only a single action 16 being performed, the client system 4 sends a request 18 to reserve the item or service for the person 10 identified by the identifier 8 to the server system 6.

The server system 6 receives the identifier 8, retrieves additional information 20 which was previously stored for the person 10, receives the request 18, and generates a reservation 22 to reserve the item or service for the person 10 using the retrieved additional information 20. Preferably, the server system 6 sends a confirmation 24 of the entry of the reservation 22 for reception by the client system 4. A suitable communication network 26 is employed for communication of the identifier 8, the request 18, and the confirmation 24 between the client and server systems 4,6.

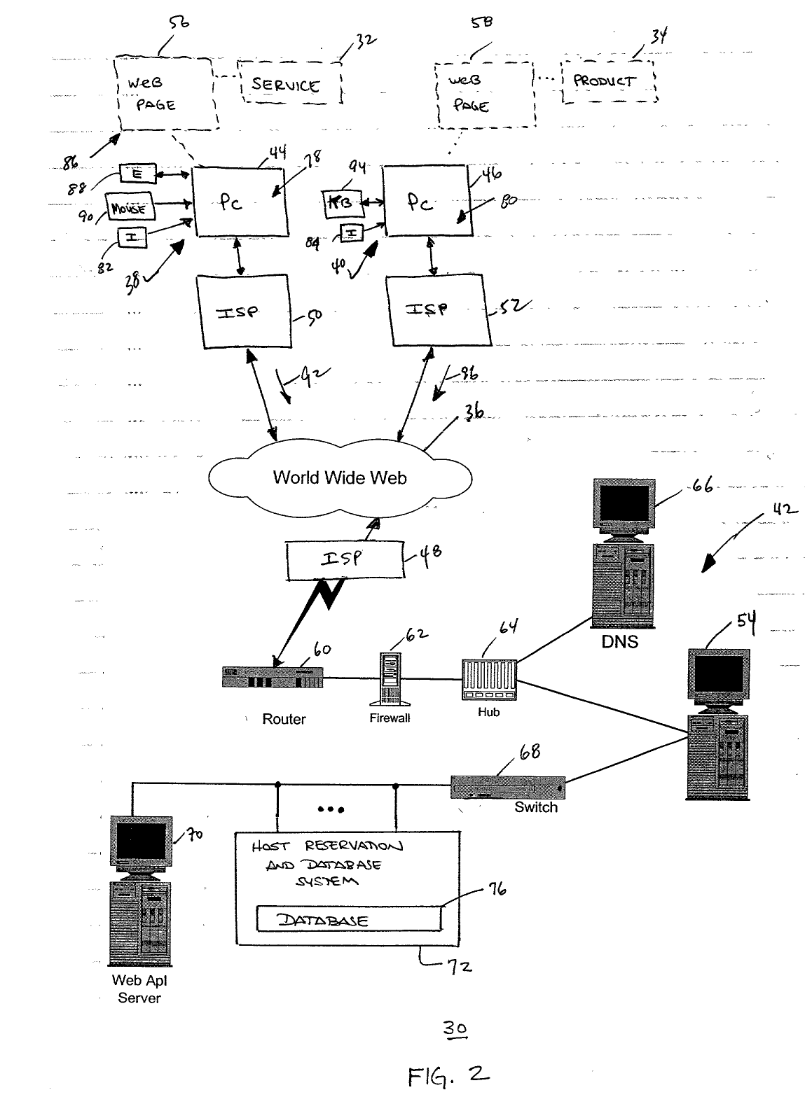

FIG. 2 shows another client/server reservation system 30, which supports single action reservation of a service 32 or a product 34 over a communication network, such as the Internet using the World Wide Web (WWW) 36. The reservation system 30 includes one or more exemplary client systems 38,40 and a server system 42. The client systems 38,40 include computers, such as the exemplary personal computers (PCs) 44,46, respectively, for various users (not shown) of the system 30. The server system 42 and the PCs 44,46 are connected to the WWW 36 by one or more Internet service providers (ISPs), such as ISPs 48 and 50,52, respectively, in order that the PCs 44,46 provide access to the WWW 36 and, thus, access to web site server 54 of the server system 42, in order to display the web pages 56,58, respectively. The web site server 54 launches various requests and creates the final display of HTML pages for the exemplary client systems 38,40. While reference has been made to the exemplary PCs 44,46 and server 54, other suitable processors such as, for example, network- or web-PCs, microcomputers, microprocessors, workstations, minicomputers or mainframe computers may be employed.

The exemplary server system 42 further includes a suitable router 60, firewall 62, hub 64, domain name server (DNS) 66, switch 68, web application server 70, and host reservation and database system 72. The DNS 66 receives HTTP requests from the PCs 44,46 to access web pages identified by URLs. In response, the web site server 54 provides HTML documents for display of the web pages 56,58 by the respective PC-based client systems 38,40. Additional HTTP requests may indicate that a user has performed a single action to effect single action reservation. The web application server 70 sends and receives requests to and from the host reservation and database system 72. That host system 72 interfaces a suitable reservation database 76 which contains additional information for various users of the system 30. In the exemplary embodiment, the database 76 stores Emerald Club profile information for a plurality of members of that car rental club, although the invention is applicable to any suitable data store which employs one or more identifiers of persons to access reservation related information for those persons, such as, for example, a database which is part of the web site server 54.

The PC-based client systems 38,40 include suitable web browsers 78,80, respectively. The server system 42 and client systems 38,40 interact by exchanging information via a communication network, which may include transmission over the Internet, although the single action reservation technique disclosed herein may be used in various environments other than the Internet. For example, single action reservation can also be employed in an electronic mail environment in which the service 32 or product 34 is described in an electronic mail message. Also, various communication channels may be used such as a local area network, wide area network, or point-to-point dial up connection.

Any suitable server system may be employed which includes one or more servers or any combination of hardware or software that can generate reservations in response to the single action being performed. The servers of the exemplary server system 42 function, for example, on a Windows NT platform with a Netscape Enterprise Server software license, although the invention is applicable to a wide range of server platforms.

Furthermore, a suitable client system may comprise any combination of hardware or software that can interact with the server system. These systems may include television-based systems or various other consumer products through which reservations may be entered. The exemplary PCs 44,46 employ, for example, the Microsoft Internet Explorer 4.0 or 5.0 browser running on Windows 95 or 98, although the invention is applicable to any suitable computer, browser, and operating system.

In the exemplary embodiment, a client system, such as PC 44, employs an identifier (I) 82 which identifies a person for purpose of entering a reservation for the service 32. The PC 46 similarly employs an identifier (I) 84 which identifies a person for purpose of entering a reservation for the product 34. The exemplary PC 44 includes a display 86 for the web page 56, which displays information identifying the exemplary service 32 to be reserved, a data entry interface (E) 88, such as a keyboard and processor, which the user employs in cooperation with the display 86, and a mouse 90 having one or more buttons (not shown) for control of the data entry and display functions. The PC 44 and browser 78, in turn, receive and process the HTML documents from the web site server 54 for display of the web page 56 on the display 86.

The processors of the PCs 44,46 employ suitable communication links to cooperatively exchange information with the server system 42 through the respective ISPs 50,52. In turn, the exemplary PC 44 sends the identifier 82 to the server system 42. Also, in response to only a single action being performed (e.g., appropriate depression of the button of the mouse 90), the PC 44 sends a request 92 to the server system 42 to reserve the exemplary service 32 for a person. In turn, the server system 42 retrieves additional information based upon the identifier 82 needed to complete the reservation for that person. Similarly, at the PC 46, in response to only a single action being performed (e.g., an appropriate depression of a key of keyboard (KB) 94), a request 96 is sent to the server system 42 to reserve the exemplary product 34 for a person, as identified by the identifier (I) 84.

In the exemplary embodiment, the server system 42 employs the identifiers 82,84 for entering reservations for persons associated with those identifiers. The database 76 is a car rental database which stores information, such as car rental club profiles, for a plurality of members of the rental club. The profiles define, for example, various information regarding those members, such as the members' car rental preferences. In this exemplary server system 42, the host system 72 receives the identifiers 82,84 as sent by the respective PCs 44,46, and receives the request 92 to reserve the service 32 and the request 96 to reserve the product 34 for the corresponding members. In response, the host system 72 retrieves the stored car rental club profile information from the database 76 for the members identified by the identifiers 82,84. Then, in response to each of the individual requests 92,96, the host system 72 generates a reservation to reserve the corresponding service 32 or product 34 for the identified member by using the retrieved stored car rental club profile information from the database 76.

One, both or more of the exemplary client systems 44,46 and the server system 42 form the client/server computer system 30 in which a global communication network, such as the Internet, provides a communication system therebetween. The exemplary WWW 36 sends the identifiers 82,84 and the requests 92,96 to the server system 42. Preferably, the server and client systems 42,44,46 employ Secure Socket Layer (SSL) security in order to enhance the security of the user's reservation information as communicated over the Internet.

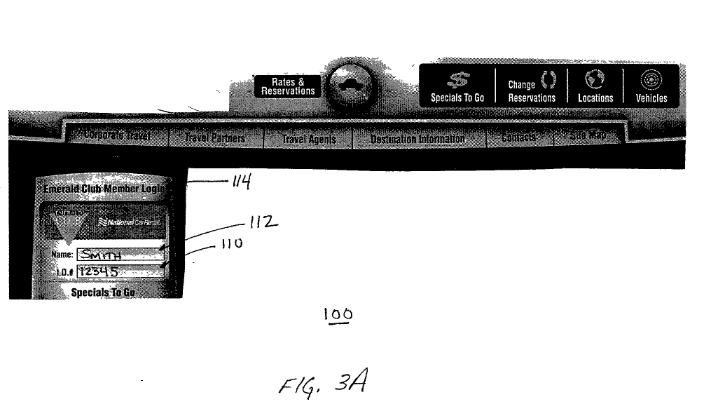

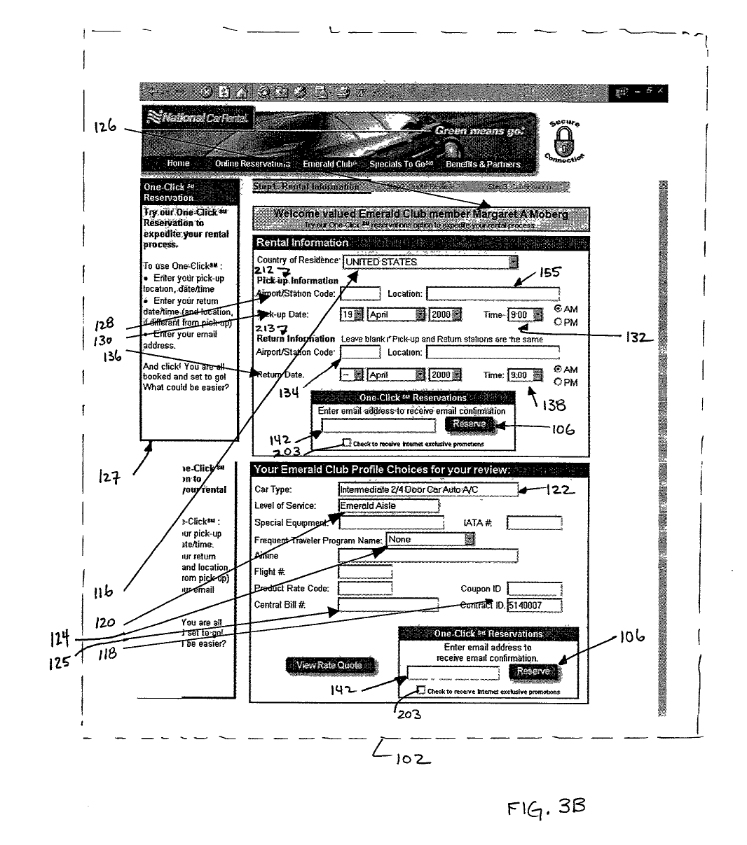

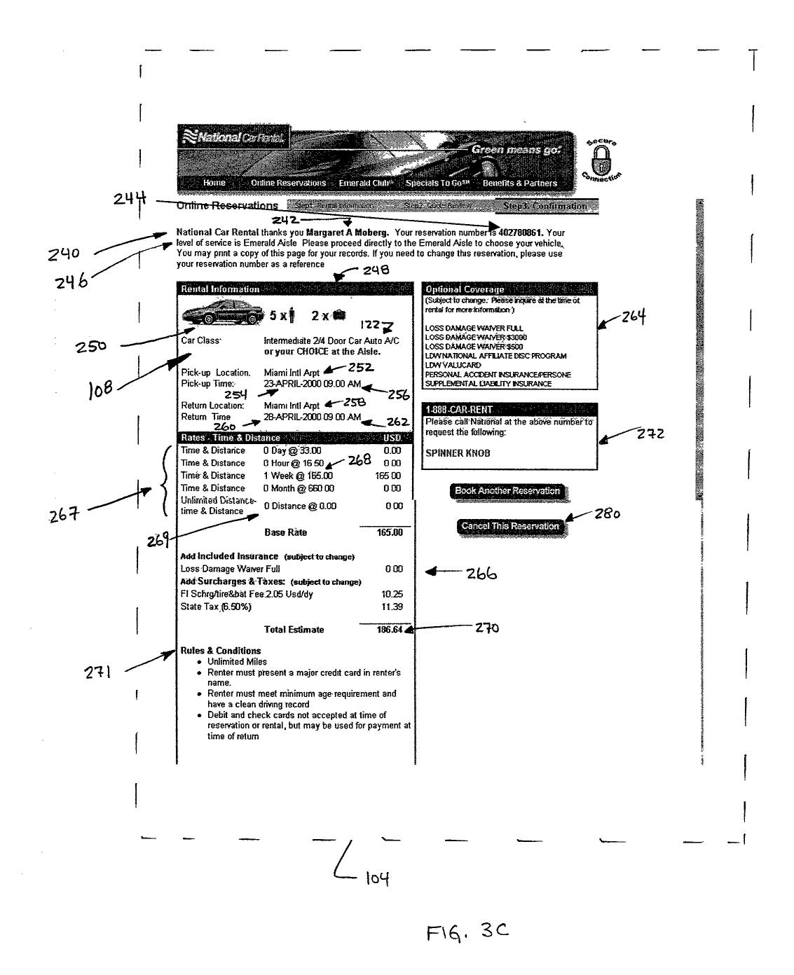

FIGS. 3A-3C illustrate a home web page display 100 which defines the identifiers 82,84, a Rental Information web page display 102, and a Confirmation web page display 104, respectively, for the reservation system 30 of FIG. 2. When the user selects the single action (e.g., by clicking on the exemplary “Reserve” button 106 of the display 102), the corresponding one of the PC client systems 38,40 sends a “Request” or “Get Record” message, including one of the respective requests 92,96, to the server system 42 requesting that the service 32 or product 34 of interest be reserved. The exemplary reservation system 30 provides reservations for car rentals, although the invention is applicable to reservations for a wide range of items or services (e.g., airline reservations; hotel reservations; vacation package reservations; frequently purchased items, such as grocery or sundry items).

After the server system 42 processes the request message, the web site server 54 sends to the requesting client system the Confirmation web page display 104 (FIG. 3C) which confirms receipt of the single action reservation. The web page display 104 contains essentially the same information as the web page display 102 (FIG. 3B) which describes the rental. Also, a reservation confirmation section 108 is displayed. The reservation confirmation section 108 confirms that the reservation has been entered. Preferably, the web page display 104 provides an opportunity for the user to review and change the single action reservation.

On one of the PC client systems 38,40, a user (e.g., a car club member, a member's travel agent, a member's secretary, a member's relative) enters the URL (e.g., http://www.nationalcar.com) for the home page of the exemplary web site stored in the web site server 54 of FIG. 2. The request is received by the DNS 66 and, in response, the web site server 54 returns the home page information in an HTML document which defines the home web page display 100 of FIG. 3A. The display 100 includes entry fields 110,112 for the member's rental Car Club Number and Last Name, respectively, although the invention is applicable to any reservation system or method which employs any suitable identifier(s) for a person.

After the home page 100 is displayed, the user enters an appropriate Last Name in entry field 112 and a corresponding Car Club Number (e.g., an Emerald Club number) in entry field 110, and clicks the “Log-in” button 114 (e.g., by employ the mouse 90 to position the displayed cursor over the button 114 before depressing the mouse button (not shown)), although the order of entry may be varied. In turn, the exemplary Last Name and Car Club Number information are sent in a “Request” or “Get Record” message to the web application server 70 of FIG. 2, which captures the login information and employs the same in a call to the host system 72. That system 72 receives and interprets this call, searches the rental database 76 for the corresponding member's car rental club profile, finds that profile information, and returns the correct profile information to the application server 70. In the exemplary embodiment, the call requests the profile information, which corresponds to the Car Club Number. Preferably, the Last Name is employed by the host system 72 as a check for an incorrectly specified Car Club Number, although that Last Name and this exemplary check are not required. Any suitable identifier, such as 82 or 84, which identifies the member may be employed.

In turn, the application server 70 receives the profile information and suitably formats the same in a subsequent HTML document for the client system's display screen. Various data fields are pre-populated in that document which defines the Rental Information web page display 102 of FIG. 3B. Those exemplary data fields specify the member's: (1) Country of Residence 116 (e.g., United States); (2) Contract ID Number 118, if applicable; and (3) desired car rental club Level of Service 120 (e.g., Meet and Greet, Meet, Emerald Aisle, Counter). The desired Car Type 122 (e.g., economy, compact, midsize, intermediate, standard, full size, SUV, minivan, premium, luxury, make and model) is not specified in the exemplary profile. Instead, a default setting is employed, although other embodiments may employ such types which are specified by the user and/or the profile.

In this manner, the exemplary server system 42 employs the member's Car Club Number (and preferably the member's Last Name for confirmation purposes) to determine information from the rental database 76 and, thereby, provide substantial improvements in the efficiency of the reservation process. For example, in addition to the three exemplary data fields discussed above, which the user or member need not remember or enter, the information from the member's profile may also include: Frequent Flyer Program Name 124, Central Billing Number 125, frequent flyer number (not shown), and credit card information (not shown).

The Rental Information web page 102 of FIG. 3B is displayed including the user's first and last name 126 (as obtained from the member's profile information). This web page 102 enables a single action reservation through the exemplary “Reserve” button 106, as discussed below. Preferably, the page 102 includes a “Help” panel 127, which explains the exemplary one-click reservations process (e.g., use the method of payment and the frequent traveler program information as set forth in the member's car club profile) and invites the user to try the same. On this page, the user enters the rental Pick-up Information including: (3) Pick-up Location 128 (e.g., Airport/Station Code), (4) Pick-up Date 130 (e.g., day, month, year), and (5) Pick-up Time 132 (e.g., hour, minute, a.m. or p.m.); rental Return Information including: (6) an optional Return Location 134 (e.g., the return Airport/Station Code if different from the Pick-up Location), (7) Return Date 136 (e.g., day, month, year), and (8) Return Time 138 (e.g., hour, minute, a.m. or p.m.). Next, the user may optionally modify: (9) the Car Type 122 (e.g., a drop down box displays various possible car types for the pick-up location only). As another option, the use may enter: (10) his/her E-mail Address 142. Finally, the user clicks on the “Reserve” button 106 to initiate the one-click reservation. Again, the order of entry or selection may be varied.

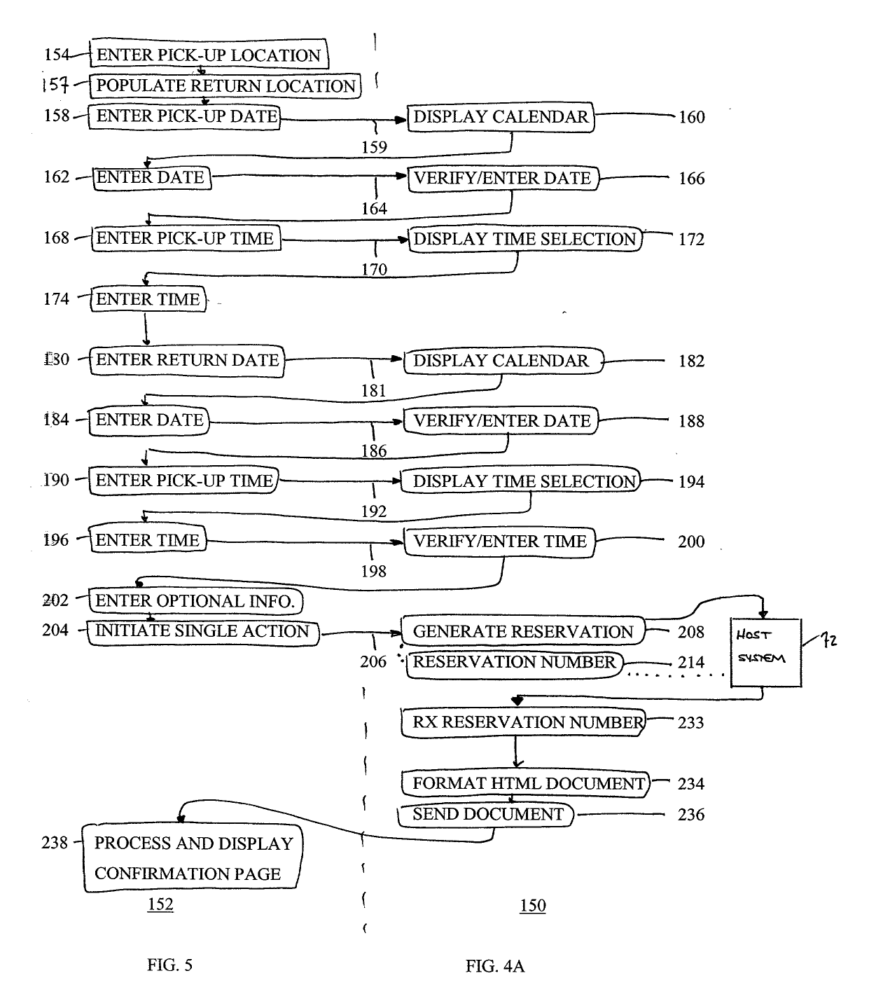

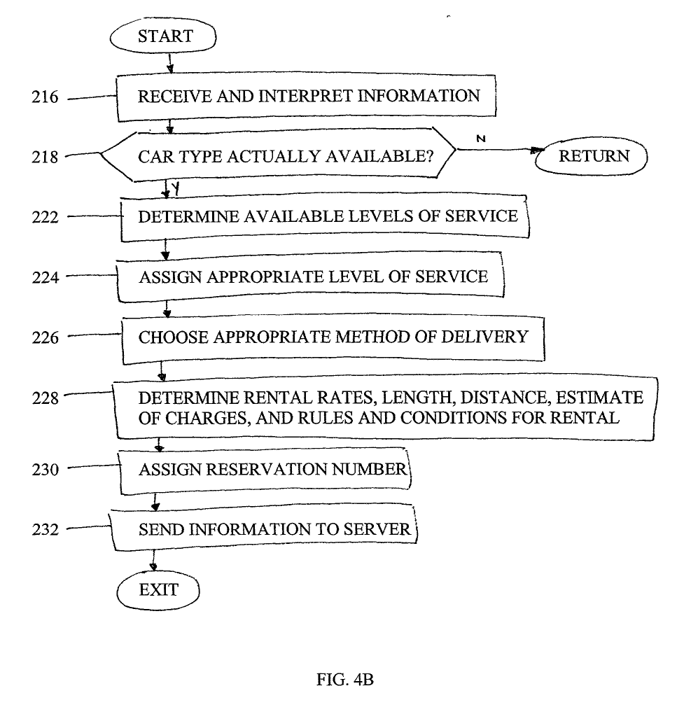

FIGS. 4A and 5 respectively show a flow diagram 150 of a server system routine, which enables single action reservations for a user, and a flow diagram 152 of a client system routine for the client/server system 30 of FIG. 2. Also referring to FIG. 3B, beginning at step 154, at the client system (e.g., client system 38 of FIG. 2), the user enters the Pick-up Location (e.g., the three-letter airport/station code or location name) in the corresponding entry field 128.

Alternatively, the user may click on a location box 155 of FIG. 3B. If the user clicks on the location box, then an internal location search engine (not shown) of the web application server 70 of the server system 42 of FIG. 2 returns with a separate HTML page within a frame set (e.g., in the exemplary Help panel 127), which explains what the user is requested to enter in the Pick-up Location entry field 128, and with a search function which allows a search by city, state or province, or country. Then, the user enters the name of the city, state, province, or country for the desired pick-up location of the proposed car rental. In response, the Help panel 127 sends a call to the internal location search engine of the application server 70 to initiate the search of the location table (e.g., in the host database 76, although the servers 54 or 70 may have that table). In response, the server 70 receives the call, initiates the search, and finds the requested location information. In turn, the server 70 returns the correct information to the Help panel 127. Next, the user clicks on the returned location information, which the client system employs to populate the Pick-up Location entry field 128.

Regardless, at 157, the client system populates the Return Location entry field 134 with the same information as the Pick-up Location entry field 128. Then, in the exemplary embodiment, at 158, the user clicks or tabs on the Pick-up Date entry field 130, which initiates a request 159 to the web application server 70. In response, at 160, the server 70 displays an exemplary two-month calendar (not shown) in the Help panel 127. The calendar includes both the current month (e.g., April) and the following month (e.g., May). Then, at 162, the user clicks on the desired day and date for the rental pick-up. This (and subsequent data entry operations on this page) initiates a request 164 to the server 70. In this manner, the server provides dynamic validation of the information, which the user enters, thereby identifying (and permitting the user to correct) any data entry error as it occurs. In response to the request 164, the server 70 verifies and populates, at 166, the Pick-up Date selections (e.g., day, month, and year) in the appropriate entry fields 130.

Next, at 168, the user clicks on the Pick-up Time entry field 132. As indicated above, this (and subsequent data entry operations on this page) initiates a request 170 to the server 70. In response, at 172, the server 70 displays an exemplary drop down box (not shown) including up to 24 exemplary times which are incremented by the half-hour (e.g., . . . 8:30, 9:00, 9:30, . . . ). The user then selects, at 174, the desired time and clicks on one of the “AM” or “PM” buttons (not shown) next to these options.

As the client system, at 157, pre-populated the Return Location entry field 134 with the same information as the Pick-up Location entry field 128, the user need not enter or edit that information unless, in fact, a change to the Return Location is desired.

Next, at 180, the user clicks or tabs on the Return Date entry field 136 which, again, initiates a request 181 to the server 70. At this point, the entry of, and the corresponding interaction by the server 70, for the Return Date and Return Time entry fields 136,138 proceeds in a similar manner as the disclosure for the respective Pick-up Date and Pick-up Time entry fields 130,132, as discussed above. Briefly, at 182, the server 70 displays an exemplary two-month calendar (not shown) in the Help panel 127. Then, at 184, the user clicks on the desired day and date for the rental return. This initiates a request 186 to the server 70. In response to the request 186, the server 70 populates, at 188, the Return Date selections (e.g., day, month, and year) in the appropriate entry fields 136.

Preferably, for purpose of increasing the efficiency of data entry for the user, the server 70 assumes that the Pick-up Month and the Pick-up Year are the same as the current month and year. Also, if the Pick-up Date is the last day of the month (e.g., April 30), then the Return Month is pre-populated to the following month (e.g., May). Similarly, if the Pick-up Date is the last day of the year (e.g., Dec. 31, 2000), then the Return Year is pre-populated to the following year (e.g., 2001).

Next, at 190, the user clicks on the Return Time entry field 138. This initiates a request 192 to the server 70. In response, at 194, the server 70 displays an exemplary drop down box (not shown) including up to 24 exemplary times which are incremented by the half-hour (e.g., . . . 8:30, 9:00, 9:30, . . . ). The user then selects, at 196, the desired time and clicks on one of the “AM” or “PM” buttons (not shown) next to these options. This initiates a request 198 to the server 70. In response, at 200, the server 70 verifies the desired time and populates the Return Time selection in the appropriate entry field 138.

In the exemplary embodiment, at 202, the user enters optional information, although this information is not required. For example, one or more entry fields, such as 142, may be provided for entry of information such as the member's Email Address. The user may also optionally select a check box 203 which invites the user's participation in, for example, the car rental company's promotions on the Internet.

Next, regardless whether the user has or has not entered the optional information, at 204, the user initiates the reservation by the exemplary single action of clicking on the “Reserve” button 106. This initiates a reservation request 206 including, for example, various entry information and default information (from the member's profile) to the server 70. For example, information 116,118,120,122 from the profile information is provided. Thus, when the user performs the exemplary single action needed to enter a reservation, the client system (e.g., client system 38 of FIG. 2) notifies the server 70 of the server system 42. In response, at 208, the web application server 70 of FIG. 2 combines the member-specific rental preference information (e.g., Country of Residence 116, Contract ID Number 118, Level of Service 120, Frequent Traveler Program Name 124, Central Billing Number 125) with the exemplary vehicle reservation information (e.g., pick-up information 212, return information 213) to initiate the exemplary reservation process by the host reservation and database system 72 for the vehicle rental. In turn, the reservation is generated including a reservation confirmation number 214, which confirms the car rental.

In particular, at 208, the server 70 employs the Pick-up and Return (or Drop-off) Locations 128,134, Dates 130,136 and Times 132,138, along with the default Car Type 122 (or car class) from the request 206, and sends that information to the host system 72. The system 72 also computes the rate for the proposed rental. As shown in FIG. 4B, in response to the information from the web application server 70, the host system 72 receives and interprets this information at 216. Next, at 218, a check of the database 76 is made to confirm whether the selected Car Type 122 is actually available at the selected Pick-up Location (station) 128 for the period of time which is defined by the Pick-up and Drop-off Dates 130,136 and Times 132,138.

If the selected type of car is actually available, then at 222, the available car rental club Levels of Service are determined from the database 76 for the selected Pick-up Location. Next, at 224, based upon the desired car rental club Level of Service 120 and the available car rental club Levels of Service as determined at 222, the appropriate level of service is assigned for that car rental club member (e.g., by giving the member the highest level of available service, as limited by what might appear in his profile). At 226, the appropriate method of delivery of the vehicle is chosen based on the appropriate level of service from 224. Then, at 228, the Car Class, the user's car rental club number, the Pick-up and Return Locations, and other information in the reservations systems and rental database 76 are employed, in order to provide the Length of Rental (based upon the number of days and hours between the Return and Pick-up Dates and Times), Distance of Rental (based upon the number of miles between the Return and Pick-up Locations), and breakdown in terms of Rates, Prices, Estimated Charges, Subtotal, Insurance Calculation, Discount Calculation, Coverage Description, Surcharges, Taxes, Total Estimate, and the Rules and Conditions for this particular rental. At 230, a unique reservation confirmation number is assigned. Finally, at 232, the foregoing information of steps 224,226,228,230 is sent back to the server 70.

Referring again to FIG. 4A, at 233, the server 70 receives this information, combines it with the computed rate from the host system 72. Next, at 234, this information and other information from the member's profile are formatted in an HTML document by the web site server 54. At 236, the HTML document is sent to the browser 78 of the exemplary client system 38. In turn, at 238 of FIG. 5, the HTML document is processed to obtain the confirmation information, and the Confirmation web page 104 of FIG. 3C is displayed. For purpose of illustration, but not limitation, the exemplary Confirmation page 104 is returned in about 5 to 10 seconds after the single action clicking of the “Reserve” button 106.

Referring to FIG. 3C, the rental Confirmation page 104 provides a visual on-screen confirmation of the reservation. Otherwise, as discussed below in connection with FIG. 7, the confirmation may also (or alternatively) be provided by an e-mail message to the user, which confirms that the desired vehicle is available for reservation. At one or both of these points, the reservation is complete.

The exemplary Confirmation page 104 includes a salutation 240, including the member's first and last names 242, which thanks the member. The actual user at the client system 38 may be the same or a different person than this member. The reservation confirmation number 244 is displayed after the salutation 240, along with the actual level of service 246 (e.g., Meet and Greet, Meet, Emerald Aisle, Counter) that the member will receive. Also displayed is a “Rental Information” box 248 which includes a picture 250 that corresponds to the selected Car Type 122 of FIG. 3B. The Rental Information box 248 also includes Pick-up Location 252, Date 254 (e.g., Pick-up Day, Pick-up Month, Pick-up Year), and Time 256 (e.g., hours, minutes, a.m. or p.m.), and the Return Location 258, Date 260 (e.g., Return Day, Return Month, Return Year) and Time 262. Further displayed are the optional coverages 264 (e.g., insurance options, such as loss damage waivers) that are available for the particular Pick-up Location (station). Another display box 266 includes, for example, the rental rates 267, the rental length 268, the rental distance 269, the currency type, and the included coverages, along with a total estimate 270 of the member's charges including taxes and surcharges, less any discounts or coupons as determined at 228 of FIG. 4B. A further display box 271 includes the rules and conditions as determined at 228 for the rental. Another display box 272 shows information for contacting the car rental company if the member needs any special equipment (e.g., equipment for a handicapped person).

After the Confirmation page 104 is displayed, the user then has the option of printing the page for the user's records. A link 280 is provided in order to give the user the opportunity to cancel the reservation.

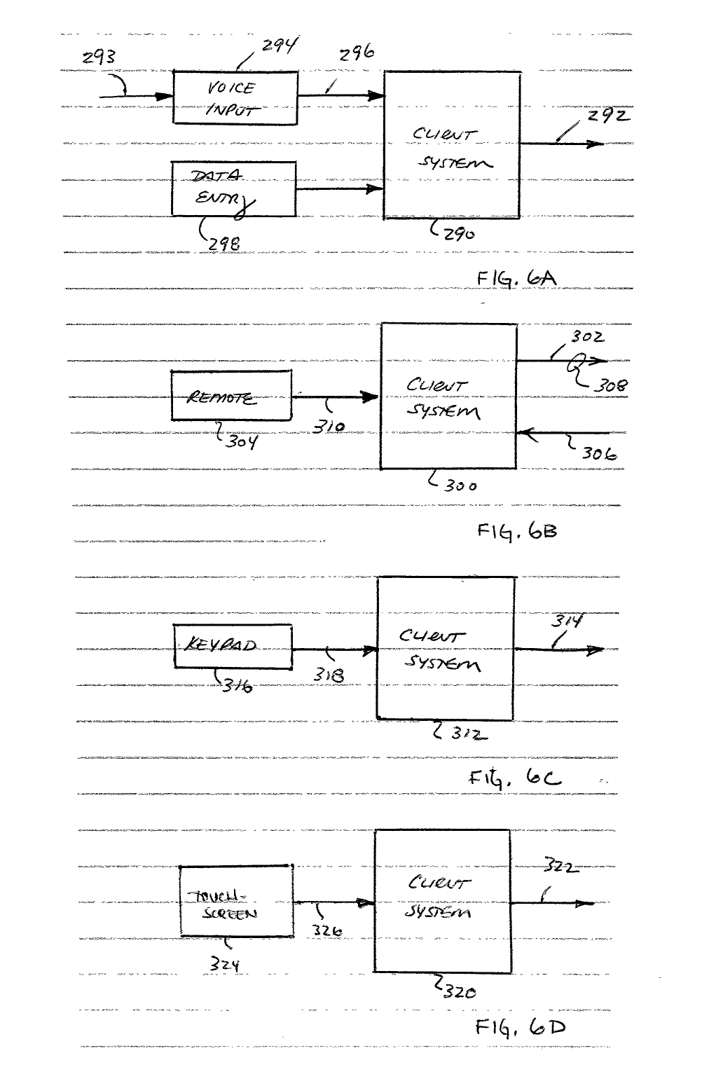

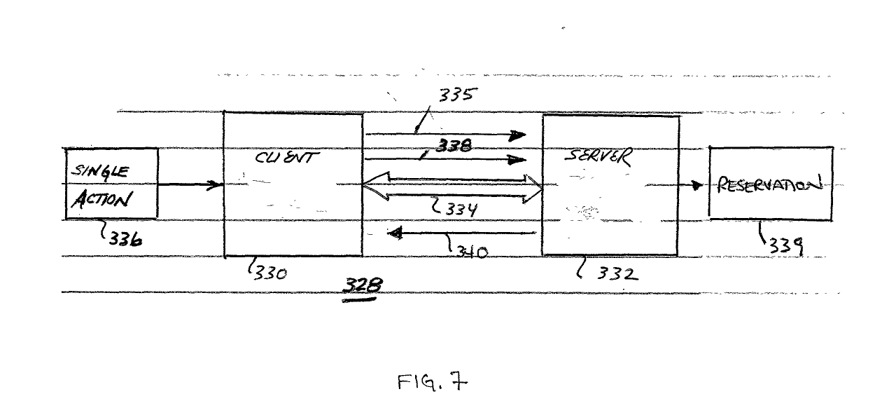

Although an exemplary point and click embodiment employing the mouse 90 of FIG. 2 has been disclosed, various different single actions may be used to effect the entry of the reservation. For example, a voice command (FIG. 6A) may be spoken by the user, a button on a television remote control device (FIG. 6B) may be depressed by the user, a key may be depressed by the user (FIG. 6C), or selection using any pointing device (FIG. 6D) may be effected by the user. Although a single action may be preceded by multiple physical movements of the user (e.g., moving the mouse 90 so that a mouse pointer (e.g., cursor) is over a soft button on a display screen), the single action generally refers to a single event at a client system that indicates to enter the reservation at a server system.

For example, as shown in FIG. 6A, a client system 290 initiates a single action request 292 for a reservation after receiving a suitable sound 293 at voice input sub-system 294. For example, the user may generate a suitable sound by speaking the exemplary word “reserve” which is detected by sound input 294. The output 296 of the sound input 294 is input by the client system 290 and is processed in a similar manner as step 204 of FIG. 5. Entry of user originated reservation data into the client system 290 may be provided through either or both of data entry sub-system 298 (e.g., a keyboard, other suitable data entry device) or the voice input sub-system 294.

FIG. 6B is a block diagram of another client system 300 which initiates a single action request 302 for a reservation after receiving a suitable input from a television remote control 304. In the exemplary embodiment, the client system 300 has a television reception function 306 as well as an external communication function 308. For example, the user may generate the single action request 302 by depressing a button (not shown) of the remote control 304. The output 310 of the remote control 304 is input by the client system 300 and is processed in a similar manner as step 204 of FIG. 5. Entry of user originated reservation data into the client system 300 may also be provided through the remote control 304 and/or another input sub-system (not shown).

FIG. 6C is a block diagram of a client system 312 which initiates a single action request 314 for a reservation after receiving a suitable input from a keypad 316. For example, the user may generate the input by depressing a particular key (not shown) of the keypad. The output 318 of the keypad 316 is input by the client system 312 and is processed in a similar manner as step 204 of FIG. 5. Entry of user originated reservation data into the client system 312 may also be provided through the keypad 316 and/or another input sub-system (not shown) (e.g., a keyboard).

FIG. 6D is a block diagram of a client system 320 which initiates a single action request 322 for a reservation after receiving a suitable input from a touchscreen 324. For example, the user may generate the input by touching a region of a display screen (not shown) which is detected by the touchscreen 324. The output 326 of the touchscreen 324 is input by the client system 320 and is processed in a similar manner as step 204 of FIG. 5. Entry of user originated reservation data into the client system 320 is preferably also provided through the touchscreen 324, although an additional input sub-system (not shown) may be employed.

Although various pointing devices such as a mouse and a touchscreen have been disclosed, the invention is applicable to any input device (e.g., a trackball), which provides a suitable single action input to a client system for initiating a request for a reservation (e.g., positioning a cursor over a predefined area of a displayed indication (e.g., “Reserve”) and initiating a single action to select that indication).

FIG. 7 is block diagram of a client/server system 328 including a client 330, a server 332 and a suitable communication network 334 therebetween. The client 330 sends an identifier 335 of a person seeking a reservation. The client 330 also detects a single action 336 and, in response, initiates a request 338 for a reservation by sending a suitable message over the network 334. In response, the server 332 enters a reservation 339 and sends a confirmation of the same by employing an exemplary email message 340 to the person or other user at the client system 330.

The exemplary rental reservation system 30 provides a substantial improvement in the efficiency of reserving a vehicle, such as a car, over the Internet. After the user's identification is entered on the exemplary first web page 100 (e.g., car rental club number and, preferably, car rental club member's last name) and the reservation process is initiated by a first click of the exemplary button 114, the process is streamlined to allow the users to reserve vehicles with minimal data entry followed by a single click which is initiated, for example, at step 204 of FIG. 5. Thus, the exemplary improved methodology reduces data inputs from about 30 with about seven clicks in a prior attempt, to between 7 and 10 with two clicks, which represents more than a two-thirds reduction in inputs and more than a 71% reduction in the number of clicks employed to reserve a vehicle.

In this manner, many of the time consuming steps facing users of Internet-based car rental services have been eliminated. The exemplary on-line reservation system 30 reduces the entry of significant amounts of redundant data, speeds on-line reservations with the minimal amount of steps, and eliminates remembering of personal rental preferences, such as the user's frequent flyer programs and their associated membership numbers, and the user's company's contract rate code for a particular rental vendor. Accordingly, users of the system 30 save a significant amount of time. Therefore, the system 30 substantially increases the speed, convenience, ease-of-use, and incentive for users to do business on the Internet. Hence, car rental counters and telephone calls may be avoided. Furthermore, a lengthy, redundant, information entry process is also avoided.

While for clarity of disclosure reference has been made herein to the exemplary PCs 44,46 for displaying reservation-related information, it will be appreciated that such information may be stored, printed on hard copy, be computer modified, be combined with other data, or be transmitted for display elsewhere. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

I claim:

1. A method of entering a reservation comprising:
under control of a client system,
sending an identifier of a person to a server system,
displaying information identifying an item or service to be reserved, and
in response to only a single action being performed, sending a request to reserve the item or service for the person identified by the identifier to the server system; and
under control of the server system,
receiving the identifier,
retrieving additional information previously stored for the person identified by the identifier,
receiving the request, and
generating a reservation to reserve the item or service for the person identified by the identifier using the retrieved additional information.

2. The method of claim 1 including
employing as said information identifying an item or service rental pick-up information, rental return information, and type of said item or service.

3. The method of claim 1 including
clicking a button as the single action.

4. The method of claim 1 including
speaking a sound as the single action.

5. The method of claim 1 including
employing as the identifier a vehicle rental club number.

6. The method of claim 5 including
employing said person having a name; and
sending the name of the person with the identifier.

7. The method of claim 1 including
sending from the server system to the client system a confirmation that the reservation was entered.

8. The method of claim 7 including
specifying an e-mail address; and
sending said confirmation in an e-mail message to said e-mail address.

9. The method of claim 7 including
sending said confirmation in an HTML document;
processing said HTML document to obtain confirmation information; and
displaying said confirmation information on a web page.

10. The method of claim 1 including
employing a car as said item; and
employing car rental club profile information as said additional information.

11. A client system employing an identifier, which identifies a person, for entering a reservation, said client system comprising:
a display component displaying information identifying an item or service to be reserved;
a data entry component cooperating with said display component; and
a communication component cooperating with said data entry component, said communication component sending the identifier to a server system, in order that the server system can retrieve additional information based upon the identifier needed to complete the reservation, and in response to only a single action being performed, sending a request to the server system to reserve the item or service for the person.

12. The client system of claim 11 wherein the display component is a browser.

13. The client system of claim 11 wherein the data entry component includes a processor and a mouse having a button; and wherein the single action is clicking the button of the mouse.

14. The client system of claim 11 wherein said communication component receives an HTML document from the server system; and wherein said data entry component processes said HTML document for display by said display component.

15. The client system of claim 11 wherein said item or service includes a vehicle rental; and wherein said information identifying the vehicle rental includes rental pick-up information, rental return information, and type of vehicle.

16. The client system of claim 15 wherein the rental pick-up information includes pick-up location, pick-up date, and pick-up time.

17. The client system of claim 15 wherein the rental return information includes return location, return date, and return time.

18. The client system of claim 15 wherein the type of vehicle is a car type.

19. The client system of claim 15 wherein the person has an e-mail address; and wherein said information identifying the vehicle rental further includes the e-mail address of said person.

20. The client system of claim 11 wherein said communication component receives a confirmation from the server system that the reservation was entered.

21. The client system of claim 11 wherein said identifier is a vehicle rental club number.

22. A server system employing an identifier, which identifies a person, for entering a reservation, said server system comprising:
a data storage component storing information for a plurality of persons;
a receiving component receiving the identifier, and receiving a request to reserve an item or service for the person, said request being sent in response to only a single action being performed;
a retrieval component retrieving the stored information from the data storage component for the person identified by the identifier; and
a reservation entry component generating a reservation to reserve the item or service for the person identified by the identifier using the retrieved stored information.

23. The server system of claim 22 wherein the request is sent by a client system in response to the single action being performed.

24. The server system of claim 22 wherein the item is a vehicle; and wherein the reservation is for the vehicle.

25. The server system of claim 24 wherein the vehicle is a land-based vehicle.

26. The server system of claim 25 wherein the land-based vehicle is selected from the list consisting of a car, a truck, and a sport utility vehicle.

27. The server system of claim 22 wherein said reservation entry component generates said reservation including a reservation number.

28. The server system of claim 27 wherein said reservation entry component generates said reservation for a rental; and wherein said reservation further includes a length of the rental, rental rate information, and estimated charges for the rental.

29. The server system of claim 22 wherein said data storage medium is a car rental club database; wherein said identifier is a car rental club number for accessing said database; and wherein said stored information is a car rental club profile which is accessed from said database.

30. The server system of claim 29 wherein said person has rental preferences; wherein said car rental club profile includes said rental preferences; and wherein said reservation entry component includes means employing said rental preferences for generating said reservation.

31. A method for reserving an item or service using a client system, said method comprising:
employing an identifier which identifies a person;
sending the identifier to a server system, said server system for retrieving additional information based upon the identifier and needed to complete a reservation;
displaying information which identifies the item or service to be reserved; and
sending, in response to only a single action being performed, a request to the server system to reserve the item or service for the person.

32. A method for reserving an item or service using a server system, said method comprising:
storing information for a plurality of persons;
receiving an identifier of a person;
retrieving the stored information for the person identified by the identifier;
receiving a request to reserve the item or service for the person, said request being sent in response to only a single action being performed; and
generating the reservation to reserve the item or service for the person identified by the identifier using the retrieved stored information.

33. A computer system employing an identifier, which identifies a person, for entering a reservation, said computer system comprising:
a client system comprising:
a display component displaying information identifying an item or service to be reserved,
a data entry component cooperating with said display component, and
a communication component cooperating with said data entry component;
a server system comprising:
a data storage medium storing information for a plurality of persons,
a receiving component receiving said identifier, and receiving a request to reserve an item or service for the person, said request being sent in response to only a single action being performed,
a retrieval component retrieving the stored information from the data storage component for the person identified by the identifier, and
a reservation entry component generating a reservation to reserve the item or service for the person identified by the identifier using the retrieved stored information; and
a communication system between said client system and said server system, with said communication system sending the identifier to the server system, and in response to only said single action being performed, sending said request to the server system.

34. The computer system of claim 33 wherein said communication system is a global communication network.

35. The computer system of claim 34 wherein the global communication network is the Internet.

36. The computer system of claim 33 wherein the single action is clicking a mouse button when a cursor is positioned over a predefined area of the displayed information.

37. The computer system of claim 33 wherein the single action is a sound generated by a user.

38. The computer system of claim 33 wherein the single action is a selection using a television remote control.

39. The computer system of claim 33 wherein the single action is depressing a key on a key pad.

40. The computer system of claim 33 wherein the single action is a selection using a pointing device.

41. The computer system of claim 40 wherein the pointing device is selected from the list consisting of a touchscreen, and a mouse.

42. The computer system of claim 33 wherein the single action is a selection of a displayed indication.

43. The computer system of claim 33 wherein said stored information for one of said persons includes country of residence, credit card information, frequent flyer program, and frequent flyer number.

44. The computer system of claim 33 wherein said item or service includes a vehicle rental; and wherein said information identifying an item or service includes information regarding the vehicle rental.

45. The computer system of claim 44 wherein said information regarding the vehicle rental includes rental pick-up information, rental return information, and type of vehicle.

46. The computer system of claim 45 wherein said rental return information includes return date, and return time.

47. The computer system of claim 46 wherein said rental return information further includes return location.

48. The computer system of claim 45 wherein said rental pick-up information includes pick-up date, pick-up month and pick-up year; wherein said rental return information includes return month and return year; and wherein said reservation entry component includes means for determining the return month and the return year.

49. The computer system of claim 48 wherein said means for determining the return month and the return year includes means employing the pick-up month as the return month if the pick-up date is not the last day of a month and, alternatively, employing the month following the pick-up month as the return month, and means employing the pick-up year as the return year if the pick-up date is not the last day of a year and, alternatively, employing the year following the pick-up year as the return year.

50. The computer system of claim 33 wherein said data storage component includes a computer which accesses a car rental database.

51. The computer system of claim 33 wherein said data entry component includes means for initiating the single action being performed, and means for sending said request in response to initiation of said single action.

52. The computer system of claim 51 wherein said data entry component further includes means for entering said information identifying an item or service to be reserved, and means for entering optional information prior to initiating the single action being performed.

53. The computer system of claim 52 wherein the person has an email address; and wherein said optional information includes said e-mail address.

54. The computer system of claim 33 wherein said data entry component and said display component cooperate to display said information identifying an item or service to be reserved on a single screen before said single action is performed.
